(19) United States
(12) Patent Application Publication
(10) Pub. No.: US 2026/0203094 A1
(43) Pub. Date: Jul. 16, 2026

(54) LARGE LANGUAGE MODEL BASED CONVERSATIONAL DATA UPDATE

(71) Applicant: o9 Solutions, Inc., Dallas, TX (US)

(72) Inventors: Rajeev Karri, Bangalore (IN); Srinath Goud Vanga, San Jose, CA (US); Koustuv Chatterjee, Gilbert, AZ (US)

(21) Appl. No.: 19/561,082

(22) Filed: Mar. 9, 2026

Related U.S. Application Data
(63) Continuation of application No. 18/824,549, filed on Sep. 4, 2024.
(60) Provisional application No. 63/605,090, filed on Dec. 1, 2023.

(30) Foreign Application Priority Data
Sep. 4, 2023 (IN) 202311059413

(51) Int. Cl. G06F 9/455; G06F 16/23; G06F 40/211

(52) U.S. Cl. CPC G06F 9/45558; G06F 16/2379; G06F 40/211; G06F 2009/45562

(57) ABSTRACT

Systems and techniques for large language model based conversational data update are described herein. A natural language input is received that requests a data update via a user interface. The input is evaluated using AI and a large language model to determine update intent. A data update policy is selected and an update command is generated. A virtual data container is created with a subset of data, where the update is executed. The modified data is displayed for user review. Upon confirmation, the update is executed in the main data structure and the virtual container deleted.

### CLAIM OF PRIORITY

This patent application is a continuation of U.S. patent application Ser. No. 18/824,549, filed Sep. 4, 2024, which application claims the benefit of U.S. Provisional Patent Application No. 63/605,090, filed Dec. 1, 2023, and claims the benefit of India Patent Application No. 202311059413, filed Sep. 4, 2023, which are incorporated by reference herein in their entireties.

### TECHNICAL FIELD

Embodiments described herein generally relate to natural language-based command processing and, in some embodiments, more specifically to reduction of data errors in data updates based on natural language commands.

### BACKGROUND

Commands issued in natural language may be converted into application specific commands to perform computing operations. There may be errors in the natural language processing or command conversion that result in the presence of errors in the electronic data. Users may wish to provide natural language commands while minimizing data errors.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system for large language model based conversational data update, according to an embodiment.

FIG. 2 is a flowchart diagram of an example process for large language model based conversational data update, according to an embodiment.

FIG. 3 illustrates an example data flow for agent interaction in large language model based conversational data update, according to an embodiment.

FIG. 4 illustrates and example of a virtual container workflow for large language model based conversational data update, according to an embodiment.

FIG. 5 illustrates an example of an intent classification process for large language model based conversational data update, according to an embodiment.

FIG. 6 illustrates an example of an access control and authorization process for large language model based conversational data update, according to an embodiment.

FIG. 7 illustrates an example of a data flow for composite action creation for large language model based conversational data update, according to an embodiment.

FIG. 8 illustrates an example of an entity resolution process for large language model based conversational data update, according to an embodiment.

FIG. 9 illustrates an example of a method for large language model based conversational data update, according to an embodiment.

FIG. 10 illustrates an example of a method for updating data using a large language model, according to an embodiment.

FIG. 11 is a block diagram illustrating an example of a machine upon which one or more embodiments may be implemented.

### DETAILED DESCRIPTION

Natural language update request may have variable fidelity which may lead to errors in electronic data updates based on natural language command issuance. These electronic data update errors may corrupt the base computer system data and may negatively alter the computing data structure holding the electronic data leading to miscalculations and erroneous data output for the user and other users of the data structure. Described herein are system and methods that convert a natural language request of a user into a set of instructions to update a certain set of data in a planning tool and carry out the request safely while protecting the system from inadvertent user or system errors.

The user interacts with a user interface (UI) including natural language UI controls enabling the user to express his/her data update request in a natural language. A series of technical tasks are identified based on an evaluation of the natural language inputs to identify a series of technical steps associated with an identified intent of the user. The series of technical steps include operations to be performed by the computing system and within a data structure to complete the intention.

Intent detection may be completed by a Large Language Model (LLM). When the intent of data update is understood, a series of operations are orchestrated to be performed by the computing device. Each orchestrated operation is carried out by one or more pre-programmed agents known to the orchestrator. In an example, a dataset specific Named Entity Recognition (NER) agent may search a dataset specific named entity cache to efficiently find suitable data element matches. Given the set of matched entities and the request submitted by the user, a query generator agent composes a query in a structured query language that to execute the data update request identified as an intent of the user from the natural language input.

Fidelity of translation from natural language to structured query language is difficult to guarantee. To address variability in fidelity, a new virtual container is created to hold the updated data without disturbing the original data. The virtual container only holds the changed data cells and not the full dataset since that would be extremely expensive in terms of memory footprint required. The data update commands are executed in the virtual container and the results are displayed to the user via the UI. Results from the virtual container are intelligently merged with the data in the base database so the user is presented with a complete view. Upon user inspection and consent, the commands to update the data based on identified user intent either proceeds to commitment of the data changes from the virtual container into the real database, or the changes are discarded if the user provides an indication (e.g., via natural language response, activation of a UI control, etc.) that the changes are unacceptable after inspecting the results. This allows for a safe and reliable data update in the system while still allowing the user the benefit of being able to perform data changes via natural language.

### Technical Architecture

### Atomic Agents

Atomic agents are responsible for accomplishing specific tasks within the system and they are LLM powered. While some are provided by the system, users can also create third-party agents. Each agent declares a configuration containing input and output parameters, along with specific schemas. These schemas determine the order in which agents can be connected as upstream or downstream in a workflow.

Each agent has a specific input policy, which indicates what slots are required from the user before they can finish the task. Agents are capable of conversations and they ask clarification questions from users.

### Entity Resolution Agent

This agent is responsible for extracting entities in the given user utterance and map them into entities in the system. As o9's system can have multiple tenants, it is capable of limiting the search results to a specific tenant. If more than one result returned for a specific phrase, users are provided with chips to select from to disambiguate.

### Update Agent

Update agent takes utterances of the user and the entities to create an update query that can be applied on a database. It takes final confirmation from the user before proceeding.

### Vector Database

The vector database supports semantic searches across the system, storing both atomic agents and example queries that the atomic agent can answer. This database returns example queries that are semantically closer to the given search string.

### Entity Database

Entity database is a document database that contains all indexed entities from the system segregated by a tenant to support multi-tenant workflows. They are optionally indexed by using embeddings to support semantic search and by default support the n-gram based search.

### Large Language Model

The system utilizes transformer-based language models, specifically OpenAI GPT-4 and Claude, which are capable of following instructions and calling tools. These models are provided with prompts containing instructions and relevant contextual information.

### Common AI Service

The Common AI service performs several crucial functions within the system. Common AI service is responsible for the following: classifying a query into a specific type, generating an agent chain to execute based on the query type, executing the agent chain one by one and facilitate conversation between an agent and the user, providing the final confirmation to the user,

### Update Execution Design

Large language models are capable of impressive tasks like summarization, question answering from textual data but to be able to work in an enterprise setting, they need to be able to interact with a diverse set of systems. One of such common tasks is to update data in a business planning system, which involves several steps and calling diverse sets of systems to and multiple inputs from the user along the way.

The user starts the workflow by interacting with the conversational planning system also known as the digital assistant via a query. Once the query is provided, the common AI service takes this information, runs a set of classification models to accurately identify the intent of the query. This query is classified into one of the many types of queries supported by the system. To accurately classify the query, a retrieval augmented generation scheme is employed that first searches for several of the queries that are semantically similar to the user query and this information is then supplied to the large language model. Based on this information, the LLM classifies the task into one of the several supported types of intent.

Once the query intent is identified, the common AI then identifies the set of agents that can fulfill the query and then starts executing the agent chain one by one. In case of the update agent, this chain may include agents such as an entity resolution agent, an update data agent, and a report management agent.

The common AI service executes each agent and keeps the output in an ephemeral storage that every agent in the chain has access to. Each output is of a predefined schema, so every agent knows how to read and modify the output data of another agent in the chain. When an agent gets executed, it picks up available input information that would have either come from the user in the initial query or as part of a clarification question. For the first agent in the chain, this is just the information that the user provided in the original query but as the chain progresses, each agent will have information that gets enriched by the upstream agents. Each agent, as part of the execution, checks its policy and compares that with available data to decide whether any clarification is needed from the user as a follow up question which common AI takes and facilitates the conversation between the user and the agent.

Updates are applied to an ephemeral storage to avoid accidental updates and only upon the user confirmation they are committed. The report manager agent acts as a guard rail to show the update and its impact on the planning system before the user can commit the change.

### Access Control Layer

In an enterprise setting, access control is a must to avoid unauthorized updates. So, this data update system overlays the access control rules on top of the update commands to identify if the request can be fulfilled, else the user will be notified.

The systems and techniques discussed herein provide a variety of technical benefits. These technical benefits include, but are not limited to: Efficient use of memory: The virtual container only holds the changed data cells, not the full dataset, which significantly reduces memory footprint requirements. Improved data integrity: By executing updates in a virtual container first, the system protects the original data from inadvertent errors, reducing the risk of data corruption. Enhanced processing efficiency: The use of a dataset-specific Named Entity Recognition agent with a named entity cache allows for efficient entity matching, reducing processing time. Optimized query processing: The system leverages vector databases and large language models for intent classification, enabling faster and more accurate query processing. Reduced network traffic: By intelligently merging results from the virtual container with the base database, the system minimizes data transfer between components. Scalability: The system's architecture, including the use of specialized agents and composite action workflows, allows for easy scaling to handle complex business planning scenarios without significant resource increase. Improved user productivity: The natural language interface and automated processing reduce the time and effort required for users to perform data updates, leading to tangible efficiency gains in business planning processes.

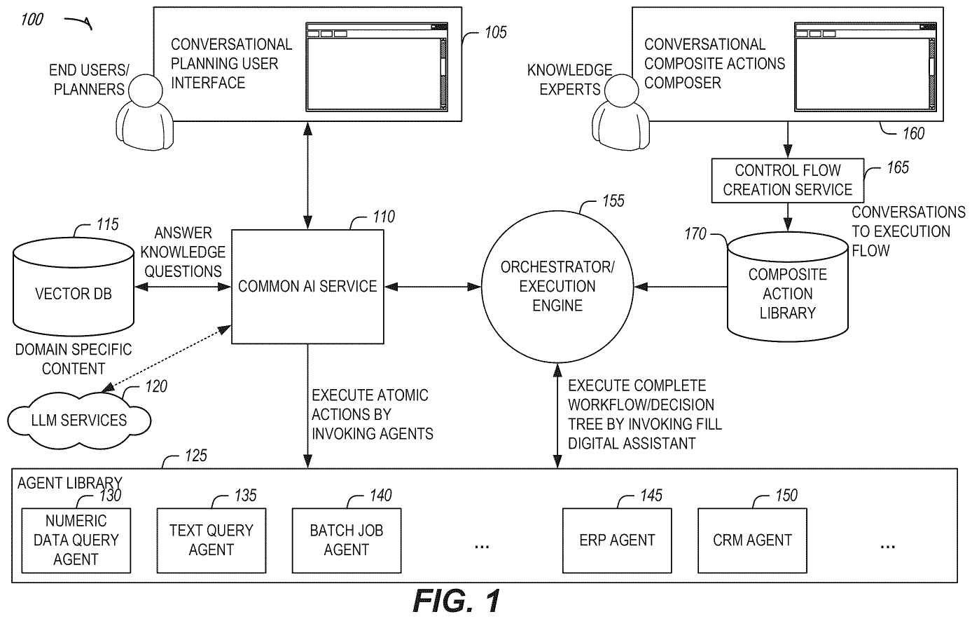

FIG. 1 is a block diagram of an example of a system 100 for large language model based conversational data update, according to an embodiment. The system 100 includes a conversational planning user interface 105 for receiving natural language input from end users; a common artificial intelligence (AI) service 110 for processing natural language input and orchestrating system operations; a vector database 115 for storing domain-specific content and intents, a connection to Large Language Model (LLM) services 120 (e.g., MICROSOFT® AZURE®, GOOGLE® Cloud Platform (GCP), AMAZON® Web Services (AWS), etc.); an agent library 125 containing various specialized agents including, by way of example and not limitation, a numeric data query agent 130 for querying numeric data sources, a text query agent 135 for querying textual data sources, a batch job agent 140 for interaction with batch command processing platforms, an enterprise resource planning (ERP) agent 145 for interaction with ERP platforms, and a customer relationship management (CRM) agent 150 for interaction with customer data; an orchestrator 155 for executing workflows and decision trees; a conversational composite actions composer 160 for creating complex workflows; a control flow creation service 165 for converting conversations to executable code; and; and a composite action library 170 for storing predefined workflows. The components of the system 100 may be implemented in hardware (e.g., via application specific integrated circuits (ASICs), field programmable gate arrays (FPGAs), etc.) or may be implemented as software instructions stored in non-transitory machine-readable medium that, when executed by at least one processor, perform operations as described herein.

The system 100 is a neuro-symbolic system that combines neural language processing techniques with symbolic systems. The system 100 utilizes state of the art language models to enable complex data update workflows via the conversation planning user interface 105.

In operation, end users interact with the system 100 through the conversational planning user interface 105 to provide natural language requests for data updates. The common AI service 110 processes these requests, leveraging the vector database 115 and LLM services 120 to understand user intent and classify queries.

When a user expresses their intent to update the data in the system 100, the common AI service 110 classifies the intent into one of the hundreds of available intents that are stored in the vector database 115. The top-k intents are passed to the LLM services 120 to identify the closest intent. When the intent is identified, the request is forwarded to an agent in the agent library 125.

In an example, based on the identified intent, the orchestrator 155 selects and executes appropriate agents from the agent library 125. These agents perform specific tasks such as entity resolution, data querying, and update operations.

The agent from the agent library 125 extracts the user input to available entities by using a combination of vector embeddings and n-gram based search. When the entities are resolved, the agent validates the update policy for the given entity and asks the user for any clarification questions that have been created to address ambiguities in the request. The clarification questions are brokered through the common AI service 110. A data update policy is dynamically generated based on the data that the user is trying by the orchestrator 155 using actions from the composite action library 170 populated with actions generated by the control flow creation service 165 based on inputs received from the conversations composite actions composer 160.

When the required pieces of information are provided to the agent, the agent attempts to get the final confirmation from the user to proceed with the update. At any point in this process, the user can request a change in the scope of the data to be updated or any other slots that may have been filled during the process.

The system 100 employs a virtual container approach to safely execute data updates without affecting the original data until user confirmation is received. This process involves creating an isolated environment, applying updates, and presenting the results to the user for approval before committing changes to the main database.

The conversational composite actions composer 160 and control flow creation service 165 enable the creation of complex workflows based on user interactions and system requirements. These workflows are stored in the composite action recipe library 170 for future use.

Throughout the process, the system maintains access control and authorization checks to ensure data security and prevent unauthorized updates.

The data update agent is authorization aware and overlays authorization rules and only allows the user to update data entities that they have access to. To avoid inadvertent updates to data, these updates are performed on a virtual container that is isolated from the master copy of the data, which protects other users of the system 100 from any errors in the updates.

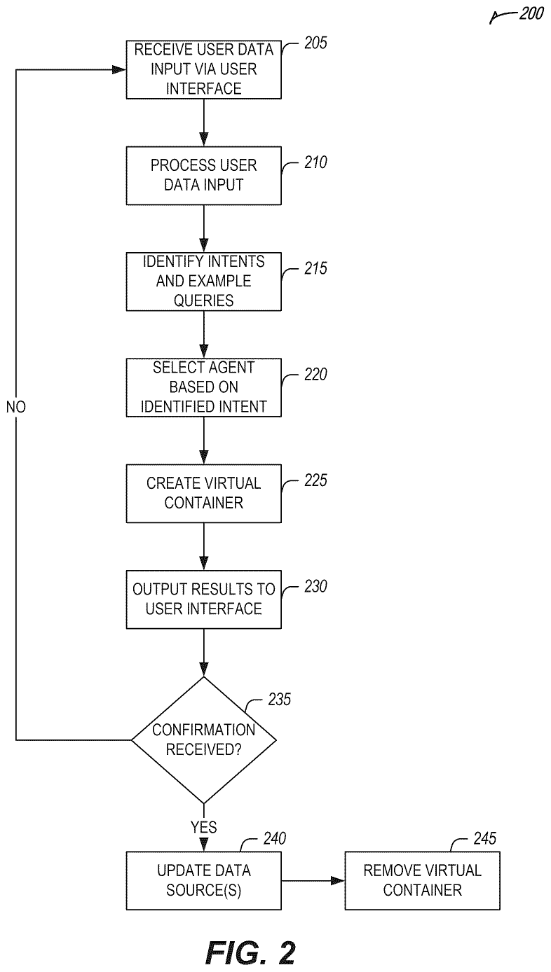

FIG. 2 is a flow diagram of an example process 200 for large language model based conversational data update, according to an embodiment.

At operation 205, a user data input is received as a natural language request entered via a user interface (e.g., the conversational planning user interface 105 as described in FIG. 1, etc.).

At operation 210, a common AI service (e.g., the common AI service 110 as described in FIG. 1, etc.)) processes the natural language input to classify the query type, generate an agent chain for execution, and facilitate conversations between agents and users.

At operation 215, intents and example queries are identified. For example, a vector database (e.g., the vector database 115 as described in FIG. 1, etc.)) stores intents and example queries for semantic searching and LLM services (e.g., LLM services 120 as described in FIG. 1, etc.) assists identifying intents and assists in query processing based on LLMs for various domains based on the query type classification, etc.

At operation 220, an orchestrator (e.g., the orchestrator 155 as described in FIG. 1, etc.) selects and executes appropriate agents based on an identified intent. The orchestrator selects the agents from an agent library (e.g., the agent library 125 as described in FIG. 1, etc.) that contains specialized agents for various tasks such as, by way of example and not limitation, an entity resolution agent that extracts and maps entities from user utterances (e.g., requests., etc.), an update agent that creates update queries based on user input and entities, and other specialized agents (e.g., the numeric data query agent 130, the text query agent 135, the batch job agent 140, the ERP agent 145, and the CRM agent 150 as described in FIG. 1, etc.).

At operation 225, a virtual container is created (e.g., by the orchestrator 155 as described in FIG. 1, etc.) to safely execute data updates without affecting original data. Access control and authorization checks are performed throughout the process 200 to ensure data security.

At operation 230, results generated in the virtual container are output to the user interface. At decision 235, it is determined if user confirmation has been received from the user interface (e.g., via the conversational planning user interface 105 as described in FIG. 1, etc.) for results presented to the user for approval.

If user confirmation of the result is determined at decision 235, one or more data sources associated with the result are updated to commit the result (e.g., at operation 240). If user rejection of the result is determined at decision 235, the user is prompted for additional input (e.g., return to operation 205, etc.). At operation 245, the virtual container is removed (e.g., by the orchestrator 155 as described in FIG. 1, etc.) upon successful update of the one or more data sources.

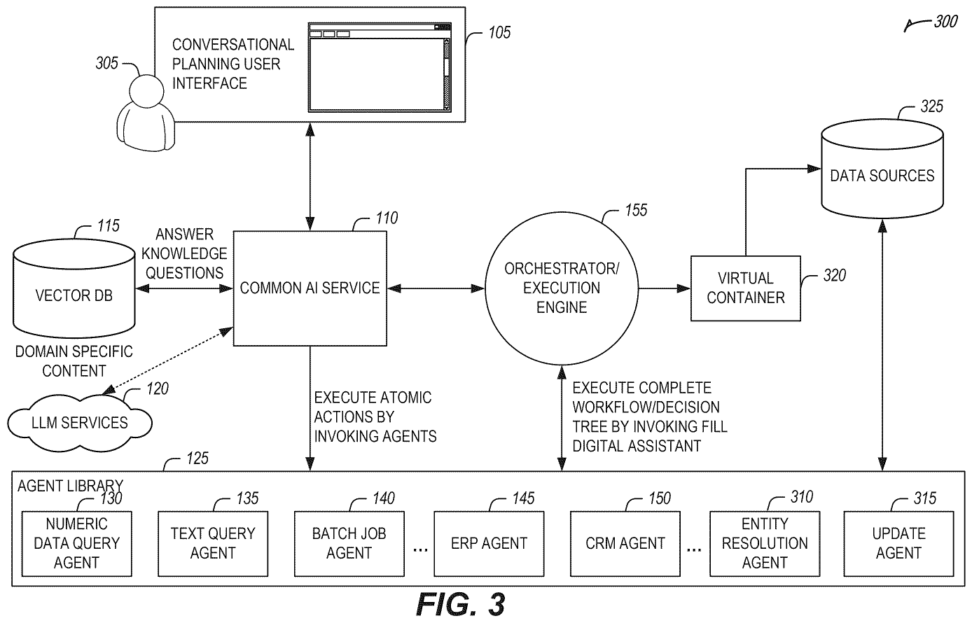

FIG. 3 illustrates an example data flow 300 for agent interaction in large language model based conversational data update, according to an embodiment.

The common AI service 110 orchestrates interactions between agents in the agent library 125 and a user 305 based on requests submitted by the user 305 via the conversational planning user interface 105. The common AI service 110 interacts with the agent library 125 that contains specialized agents including, but not limited to an entity resolution agent 310 that extracts and maps entities from user 305 requests, an update agent 315 that creates update queries based on user 305 input and entities associated with the request, the numeric data query agent 130 that interacts with numeric data sources, the text query agent 135 that interacts with text databases, the batch job agent 140 that interacts with batch job systems, the ERP agent that interacts with ERP systems, and the CRM agent that interacts with CRM systems. The common AI service 110 may invoke the agents to perform various actions to orchestrate workflows. For example, the entity resolution agent 310 interacts with the vector database 115 for entity mapping.

The common AI service 110 interacts with the orchestrator 155 to select and execute appropriate agents from the agent library 125 based on identified intent and interacts with the vector database 115 to provide semantic search capabilities for intents and queries. The common AI service 110 interacts with the LLM services 120 for assistance in intent identification and query processing. The orchestrator 155 generates a virtual container 320 as temporary storage for data updates as a result of the user 305 request. A variety of data sources 325 may be accessed by the agents in the agent library 125 and updated with contents from the virtual container 320. The data sources may include, by way of example and not limitation, numeric data sources, text databases, batch job systems, ERP systems, CRM systems, etc.

The agents in the agent library 125 interact with respective data sources 325. The update agent 315 interacts with virtual container 320 to apply updates as a result of execution of workflows by the common AI service 110 and the orchestrator 155. The updates may be applied based on confirmation received from the user 305. The orchestrator 155 manages agent execution based on input from the common AI service 110. The LLM services 120 assist the common AI service 110 in processing user 305 input received through interaction between the user interface (e.g., the conversational planning user interface 105, etc.) and the common AI service 110. When updates are complete, the virtual container may be disposed of to minimize resource utilization.

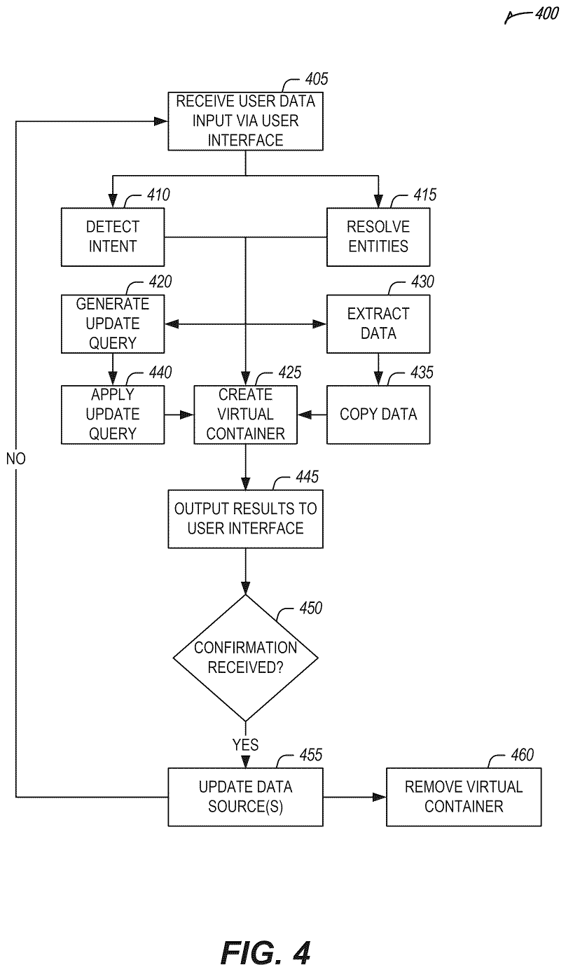

FIG. 4 illustrates and example of a virtual container process 400 for large language model based conversational data update, according to an embodiment.

At operation 405, a user data input is received as a natural language request entered via a user interface (e.g., the conversational planning user interface 105 as described in FIG. 1, etc.). At operation 410 a common AI service (e.g., the common AI service 110 as described in FIG. 1, etc.) processes the request to identify an update intent. At operation 415 an entity resolution agent (e.g., the entity resolution agent 310 as described in FIG. 3, etc.) extracts and maps entities from user request capture in the user interface.

At operation 420, an update agent (e.g., the update agent 315 as described in FIG. 3, etc.) creates a structured query based on the identified intent and resolved entities (e.g., obtained at operations 410 and 415).

At operation 425, a virtual container is created (e.g., by the orchestrator 155 as described in FIG. 1, etc.) as an isolated environment for data updates. Access control and authorization checks are performed throughout the process 400 to ensure data security.

At operation 430, a relevant subset of data is extracted. At operation 435, the data is copied into the virtual container. At operation 440 the update query is applied within the virtual container to generate update results.

At operation 445, results generated in the virtual container are output to the user interface. At decision 450, it is determined if user confirmation has been received from the user interface (e.g., via the conversational planning user interface 105 as described in FIG. 1, etc.) for results presented to the user for approval.

If user confirmation of the result is determined at decision 450, one or more data sources associated with the result are updated to commit the result (e.g., at operation 455). If user rejection of the result is determined at decision 450, the update is discarded and the user is prompted for additional input (e.g., return to operation 405, etc.). At operation 460, the virtual container is removed (e.g., by the orchestrator 155 as described in FIG. 1, etc.) upon successful update of the one or more data sources. In an example, the virtual container may be deleted when an update is rejected or may be emptied and reused for subsequent update execution for an existing user session.

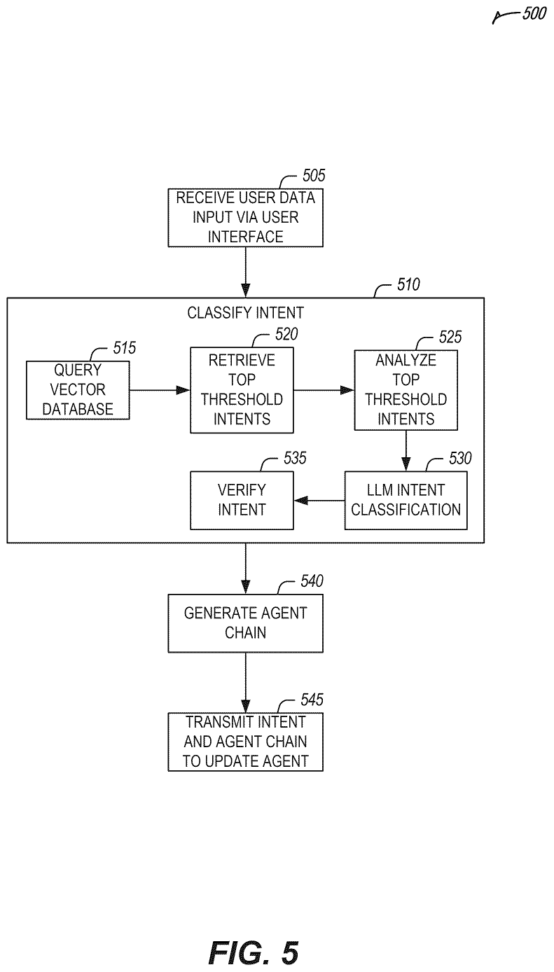

FIG. 5 illustrates an example of an intent classification process 500 for large language model based conversational data update, according to an embodiment.

At operation 505, a user data input is received as a natural language request entered via a user interface (e.g., the conversational planning user interface 105 as described in FIG. 1, etc.). At operation 410 a common AI service (e.g., the common AI service 110 as described in FIG. 1, etc.) initiates intent classification of the data input to identify an update intent. At operation 515 an entity resolution agent (e.g., the entity resolution agent 310 as described in FIG. 3, etc.) issues queries to search for semantically similar queries stored in a vector database (e.g., the vector database 115 as described in FIG. 1, etc.). At operation 520 intents with a probability within a threshold (e.g., top-k intents, etc. are retrieved based on results from the vector database query to generate an intent candidate set. At operation 525 LLM services (e.g., the LLM services 120 as described in FIG. 1, etc.) analyze the user input and intent candidate set to select an intent. At operation 530 the LLM services classify the query into one of a set of supported intent types. At operation 535 the classified intent matches are verified to ensure the intent matches the request of the user.

At operation 540, the common AI service works in conjunction with an orchestrator (e.g., the orchestrator 155 as described in FIG. 1, etc.) generates an appropriate agent chain for execution based on the classified intent. At operation 545 the classified intent and generated agent chain are passed to relevant agent(s) for further processing.

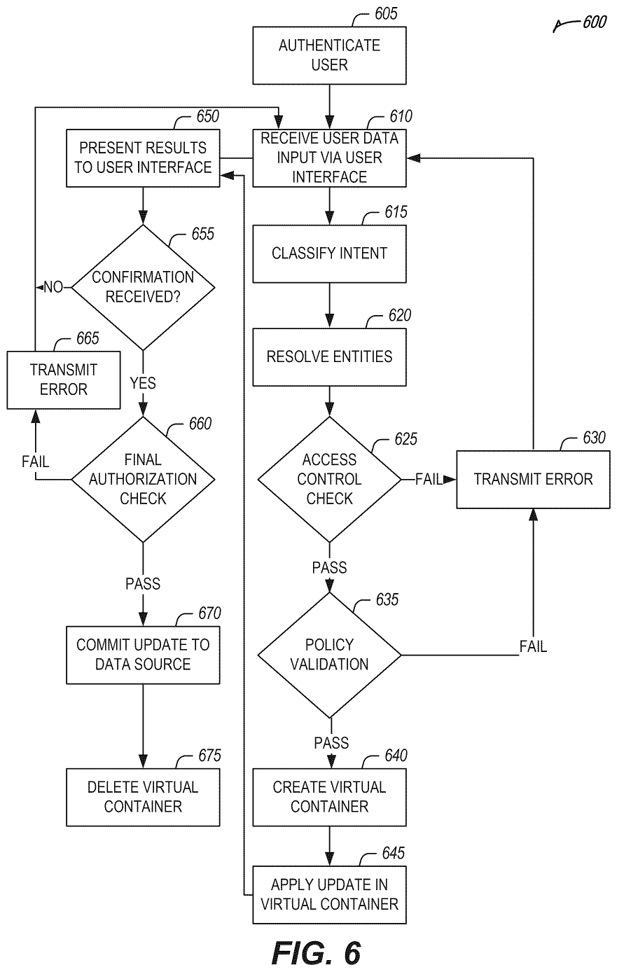

FIG. 6 illustrates an example of an access control and authorization process 600 for large language model based conversational data update, according to an embodiment.

At operation 605, user credentials provided at login are authenticated. At operation 610 a user data input is received as a natural language request entered via a user interface (e.g., the conversational planning user interface 105 as described in FIG. 1, etc.).

At operation 615, a common AI service (e.g., the common AI service 110 as described in FIG. 1, etc.) processes the natural language input to classify the intent of the data input of the user. At operation 620, an entity resolution agent (e.g., the entity resolution agent 310 as described in FIG. 3, etc.) extracts and maps entities from user requests.

At decision 625, an access control check is performed to verify authorization of the user to access identified entities. If the access control check passes, the process 600 proceeds to operation 630 and an update policy validation is performed to check if the requested update complies with predefined data update policies. If the access control check or the update policy validation fail, an error message is transmitted to the user interface at operation 630.

If the update policy validation passes, the process 600 proceeds to operation 640 and a virtual container is created as an isolated environment for the update. At operation 645, the update is applied in the virtual container. At operation 650, results of application of the update to the virtual container are displayed in the user interface. At decision 655 it is determined if the user has confirmed or rejected the update. If it is determined the user has rejected the update, the process 600 continues to operation 610 to receive additional inputs from the user.

If it is determined that the user has accepted the update at decision 655, a final authorization check is performed at decision 660 before committing changes to a data source. If the authorization check fails, an error is transmitted to the user interface at operation 665. If the final authorization check passes, the update is committed to the data source at operation 670. At operation 675, the virtual container is deleted upon successful completion of the update at operation 670.

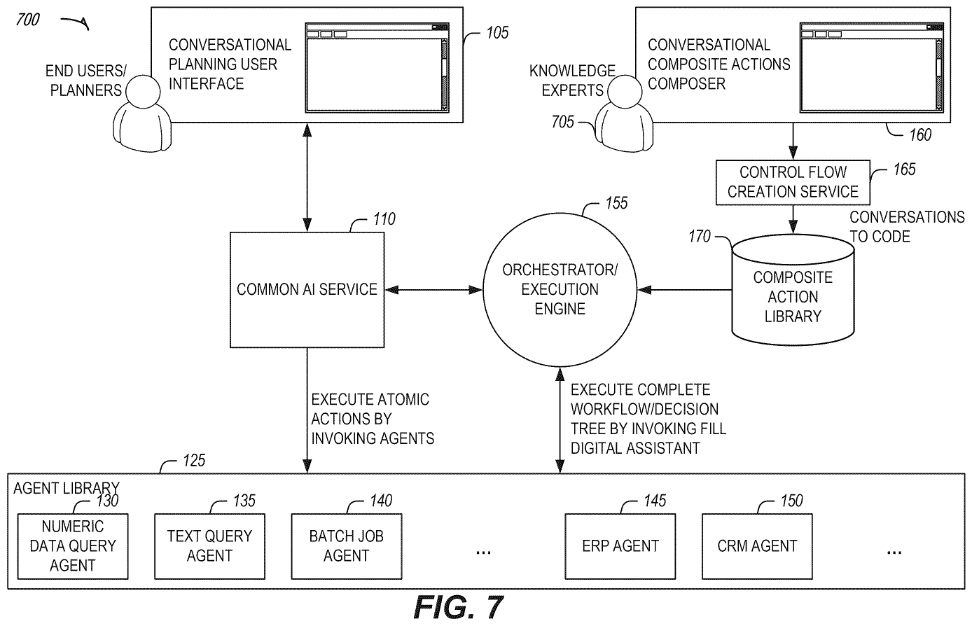

FIG. 7 illustrates an example of a data flow 700 for composite action creation for large language model based conversational data update, according to an embodiment.

Knowledge experts 705 provide examples of complex workflows or scenarios in the conversational composite actions composer 160 to create composite actions. The control flow creation service 165 converts the composite actions into executable code to be stored as composite action workflows in the composite action library 170.

The orchestrator 155 integrates the composite actions into an overall workflow for execution of tasks for intents detected from user requests received from the user interface 105. The user interface 105 allows the user to interact with and trigger the composite actions. The common AI service 110 utilizes the composite actions in processing the user requests. The common AI service 110 and the orchestrator 155 access the agent library containing specialized agents for execution of parts of the composite actions as needed.

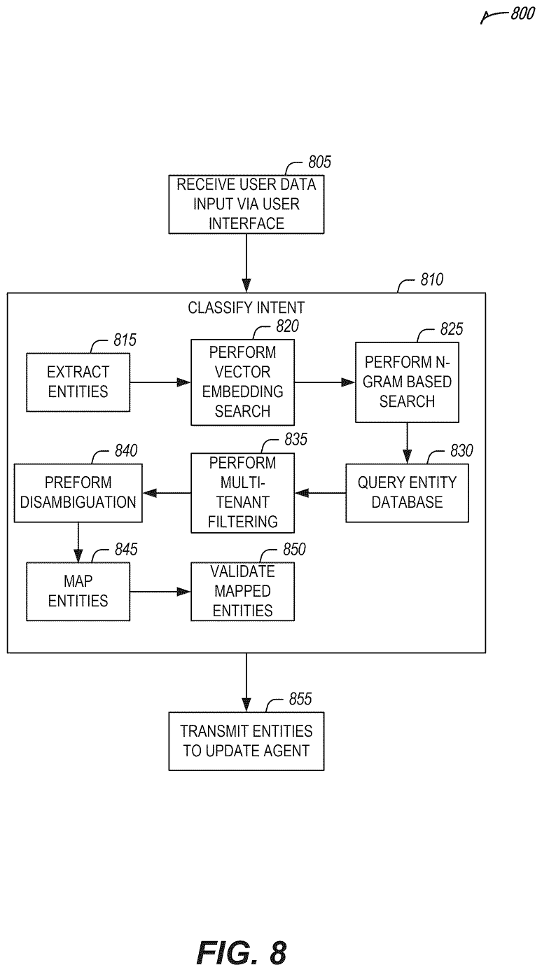

FIG. 8 illustrates an example of an entity resolution process 800 for large language model based conversational data update, according to an embodiment.

At operation 805, a user data input is received as a natural language request entered via a user interface (e.g., the conversational planning user interface 105 as described in FIG. 1, etc.).

At operation 810 an entity resolution agent (e.g., the entity resolution agent 310 as described in FIG. 3, etc.) initiates an entity extraction and mapping process. At operation 815, potential entities are identified in the user request. At operation 820, a semantic search is performed using vector embeddings. At operation 825, an n-gram based search is conducted for entity matching. At operation 830, an entity database containing indexed entities segregated by tenant are searched. At operation 835, multi-tenant filtering is conducted to filter results based on specific tenant context. At operation 840, if multiple results are returned for a specific phrase, options are provided to the user interface for user disambiguation. At operation 845, matched entities are mapped to corresponding system entities. At operation 850, the mapped entities are validated against update policies.

At operation 855, resolved entities are passed to an Update Agent (e.g., the update agent 315 as described in FIG. 3) for further processing.

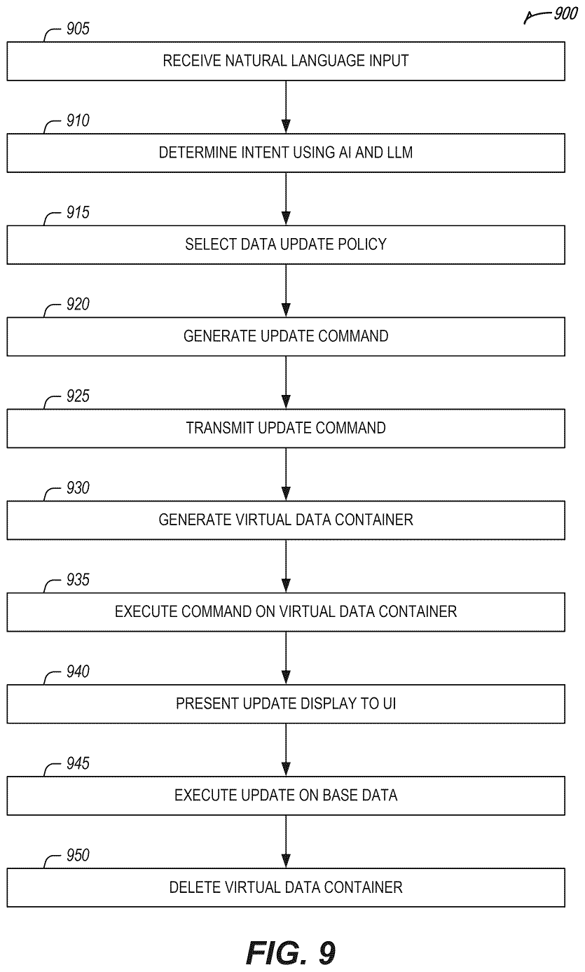

FIG. 9 illustrates an example of a method 900 for large language model based conversational data update, according to an embodiment. The method 900 may provide features as described in FIGS. 1 to 8.

A natural language input is be received from a user via conversational planning user interface (e.g., at operation 905). The natural language input is evaluated using an artificial intelligence processor and a large language model to determine a data update intent of the user (e.g., at operation 910). A data update policy is selected from a policy library using the data update intent (e.g., at operation 915). An update command is generated for an automated data update agent using the data update intent, the policy, and a set of automated update agent commands (e.g., at operation 920). The update command is transmitted to the automated data update agent (e.g., at operation 925). A virtual data container is generated comprising a subset of a data structure based on the intent (e.g., at operation 930). The update command is executed in the virtual data container to modify the subset of the data structure (e.g., at operation 935). A display based on the modified subset of the data structure is transmitted to the conversational planning user interface (e.g., at operation 940). Upon receipt of a commit command from the conversational planning user interface, the update command is executed in the data structure (e.g., at operation 945) and the virtual data container is deleted (e.g., at operation 950).

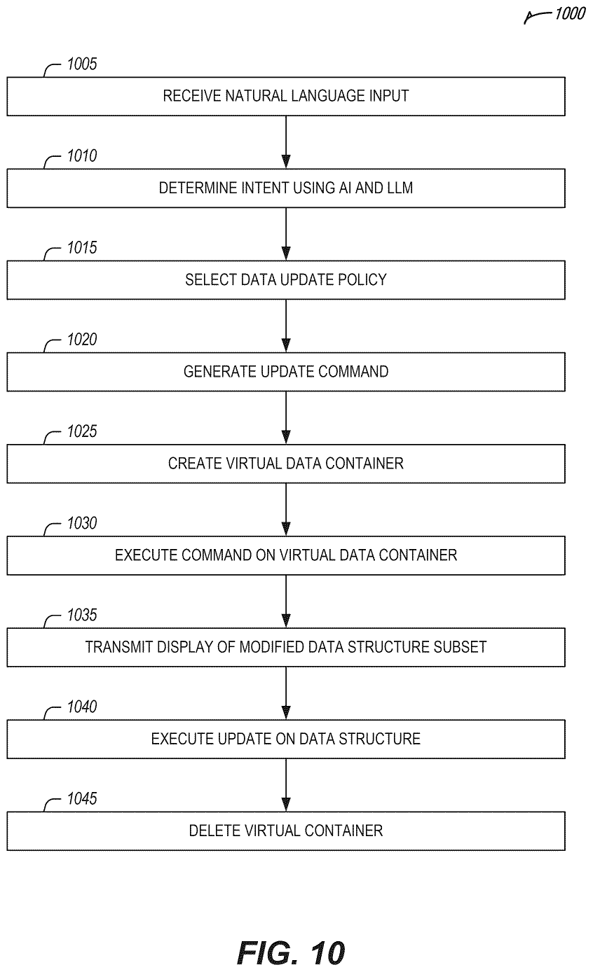

FIG. 10 illustrates an example of a method 1000 for updating data using a large language model, according to an embodiment. The method 1000 may provide features as described in FIGS. 1 to 8.

A natural language input is received that requests a data update through a user interface (e.g., at operation 1005). This input is then evaluated using an artificial intelligence processor and a large language model to determine the data update intent (e.g., at operation 1010).

Once the intent is determined, the natural language input is classified into one of several predefined intent types using a vector database and the large language model. A data update policy is selected from a policy library based on the determined data update intent (e.g., at operation 1015).

To generate the update command, entities may be extracted from the natural language input using an entity resolution agent and maps these extracted entities to system entities using a combination of vector embeddings and n-gram based search.

An update command is generated (e.g., at operation 1020) for an automated data update agent using the data update intent, the selected policy, and a set of automated update agent commands. Before executing the update, the system overlays access control rules on the update command to identify if the data update request can be fulfilled based on user authorization.

A virtual data container is created (e.g., at operation 1025), comprising a subset of a data structure based on the determined intent. The update command is executed in this virtual data container to modify the subset of the data structure (e.g., at operation 1030). This execution involves applying the update to an ephemeral storage without disturbing the original data in the data structure.

A display of the modified subset of the data structure is transmitted to the user interface (e.g., at operation 1035), merging results from the virtual data container with data in the data structure to present a complete view to the user.

Upon receiving a commit command via the user interface, the update command is executed in the actual data structure (e.g., at operation 1040) and then deletes the virtual data container (e.g., at operation 1045).

The artificial intelligence processor may include a common AI service for orchestrating interactions between specialized agents and facilitating conversations between the agents and a user.

The creation of composite action workflows using input from knowledge experts is supported. These workflows are stored in a composite action recipe library and utilized in processing subsequent user requests.

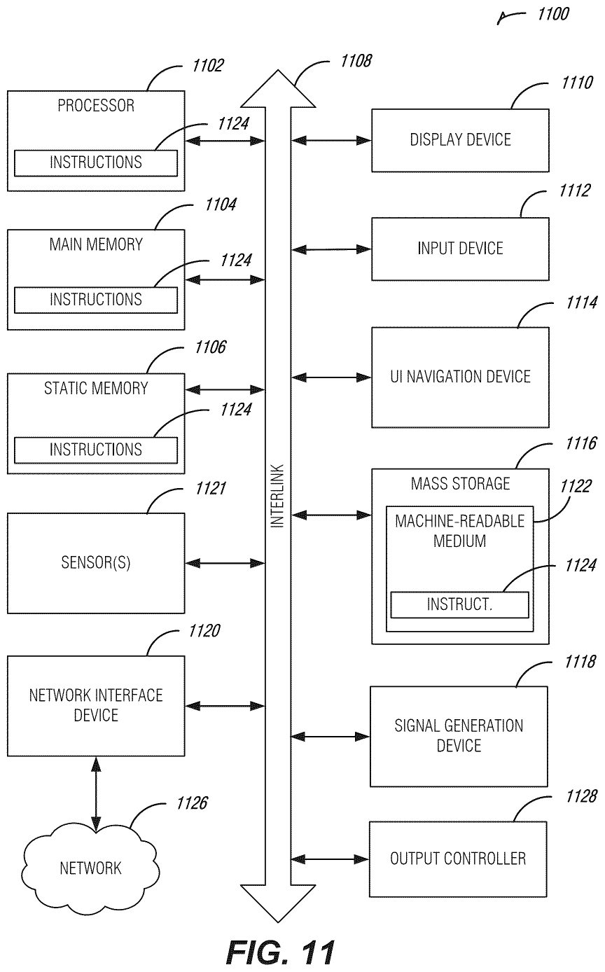

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensors. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

### Additional Notes

1The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for updating data using a large language model comprising:
at least one processor; and
memory comprising instructions that, when executed by the at least one processor, cause the at least one processor to perform operations to:
receive, via a user interface, a natural language input requesting a data update;
evaluate, using an artificial intelligence processor and the large language model, the natural language input to determine a data update intent;
select a data update policy from a policy library based on the determined data update intent;
generate an update command for an automated data update agent using the data update intent, the selected policy, and a set of automated update agent commands;
create a virtual data container comprising a subset of a data structure based on the determined intent;
execute the update command in the virtual data container to modify the subset of the data structure;
transmit a display of the modified subset of the data structure to the user interface;
upon receipt of a commit command via the user interface, execute the update command in the data structure; and
deleting the virtual data container.

2. The system of claim 1, the memory further comprising instructions that, when executed by the at least one processor, cause the at least one processor to perform operations to:
classify the natural language input into one of a plurality of predefined intent types using a vector database and the large language model.

3. The system of claim 1, the instructions to generate the update command further comprising instructions to:
extract entities from the natural language input using an entity resolution agent; and
map the extracted entities to system entities using a combination of vector embeddings and n-gram based search.

4. The system of claim 1, the memory further comprising instructions that, when executed by the at least one processor, cause the at least one processor to perform operations to:
overlay access control rules on the update command to identify if the data update request can be fulfilled based on user authorization.

5. The system of claim 1, wherein the artificial intelligence processor comprises:
a common AI service for orchestrating interactions between specialized agents and facilitating conversations between the agents and a user.

6. The system of claim 1, the memory further comprising instructions that, when executed by the at least one processor, cause the at least one processor to perform operations to:
create a composite action workflow using input from knowledge experts;
store the composite action workflow in a composite action recipe library; and
utilize the composite action workflow in processing subsequent user requests.

7. The system of claim 1, the instructions to execute the update command in the virtual data container further comprising instructions to:
apply the update to an ephemeral storage without disturbing original data in the data structure; and
merge results from the virtual data container with data in the data structure to present a complete view to a user.

8. At least one non-transitory machine-readable medium comprising instructions for updating data using a large language model that, when executed by at least one processor, cause the at least one processor to perform operations to:
receive, via a user interface, a natural language input requesting a data update;
evaluate, using an artificial intelligence processor and the large language model, the natural language input to determine a data update intent;
select a data update policy from a policy library based on the determined data update intent;
generate an update command for an automated data update agent using the data update intent, the selected policy, and a set of automated update agent commands;
create a virtual data container comprising a subset of a data structure based on the determined intent;
execute the update command in the virtual data container to modify the subset of the data structure;
transmit a display of the modified subset of the data structure to the user interface;
upon receipt of a commit command via the user interface, execute the update command in the data structure; and
deleting the virtual data container.

9. The at least one non-transitory machine-readable medium of claim 8, further comprising instructions that, when executed by the at least one processor, cause the at least one processor to perform operations to:
classify the natural language input into one of a plurality of predefined intent types using a vector database and the large language model.

10. The at least one non-transitory machine-readable medium of claim 8, the instructions to generate the update command further comprising instructions to:
extract entities from the natural language input using an entity resolution agent; and
map the extracted entities to system entities using a combination of vector embeddings and n-gram based search.

11. The at least one non-transitory machine-readable medium of claim 8, further comprising instructions that, when executed by the at least one processor, cause the at least one processor to perform operations to:
overlay access control rules on the update command to identify if the data update request can be fulfilled based on user authorization.

12. The at least one non-transitory machine-readable medium of claim 8, wherein the artificial intelligence processor comprises:
a common AI service for orchestrating interactions between specialized agents and facilitating conversations between the agents and a user.

13. The at least one non-transitory machine-readable medium of claim 8, further comprising instructions that, when executed by the at least one processor, cause the at least one processor to perform operations to:
create a composite action workflow using input from knowledge experts;
store the composite action workflow in a composite action recipe library; and
utilize the composite action workflow in processing subsequent user requests.

14. The at least one non-transitory machine-readable medium of claim 8, the instructions to execute the update command in the virtual data container further comprising instructions to:
apply the update to an ephemeral storage without disturbing original data in the data structure; and
merge results from the virtual data container with data in the data structure to present a complete view to a user.

15. A computer-implemented method for updating data using a large language model comprising:
receiving, via a user interface, a natural language input requesting a data update;
evaluating, using an artificial intelligence processor and the large language model, the natural language input to determine a data update intent;
selecting a data update policy from a policy library based on the determined data update intent;
generating an update command for an automated data update agent using the data update intent, the selected policy, and a set of automated update agent commands;
creating a virtual data container comprising a subset of a data structure based on the determined intent;
executing the update command in the virtual data container to modify the subset of the data structure;
transmitting a display of the modified subset of the data structure to the user interface;
upon receiving a commit command via the user interface, executing the update command in the data structure; and
deleting the virtual data container.

16. The method of claim 15, further comprising:
classifying the natural language input into one of a plurality of predefined intent types using a vector database and the large language model.

17. The method of claim 15, wherein generating the update command comprises:
extracting entities from the natural language input using an entity resolution agent; and
mapping the extracted entities to system entities using a combination of vector embeddings and n-gram based search.

18. The method of claim 15, further comprising:
overlaying access control rules on the update command to identify if the data update request can be fulfilled based on user authorization.

19. The method of claim 15, wherein the artificial intelligence processor comprises:
a common AI service for orchestrating interactions between specialized agents and facilitating conversations between the agents and a user.

20. The method of claim 15, further comprising:
creating a composite action workflow using input from knowledge experts;
storing the composite action workflow in a composite action recipe library; and
utilizing the composite action workflow in processing subsequent user requests.
